(19) United States
(12) Patent Application Publication
(10) Pub. No.: US 2024/0218170 A1
(43) Pub. Date: Jul. 4, 2024

(54) POLYIMIDE RESIN COMPOSITION, POLYIMIDE-BASED ADHESIVE COMPOSITION, POLYIMIDE ADHESIVE FILM, AND FLEXIBLE METAL CLAD LAMINATE FILM

(71) Applicant: NexFlex Co., Ltd., Chungcheongbuk-do (KR)

(72) Inventors: Se Jin KWON, Sejong-si (KR); Doo Hyeon KIM, Seo-gu (KR); Yu Jeong LEE, Dalseo-gu (KR); Sung Su KIM, Hwaseong-si (KR); Hyuk Jun KIM, Yuseong-gu (KR)

(73) Assignee: NexFlex Co., Ltd., Chungcheongbuk-do (KR)

(21) Appl. No.: 18/531,256

(22) Filed: Dec. 6, 2023

(30) Foreign Application Priority Data
Dec. 15, 2022 (KR) 10-2022-0176084

(51) Int. Cl. C08L 33/24; C09J 7/28; C09J 7/29; C09J 11/04; C09J 11/08; C09J 133/24

(52) U.S. Cl. CPC C08L 33/24; C09J 7/28; C09J 7/29; C09J 11/04; C09J 11/08; C09J 133/24; C09J 2301/408; C09J 2400/16

(57) ABSTRACT

A polyimide resin composition, a polyimide-based adhesive composition, a polyimide adhesive film, and a flexible metal clad laminate film are provided. The polyimide resin composition may be derived from a polyimide precursor composition including an aliphatic acid anhydride and an amine including an aromatic diamine and a dimer diamine, and the aliphatic acid anhydride may include an aliphatic tetracarboxylic acid anhydride.

### CROSS-REFERENCE TO RELATED APPLICATION

This application claims the benefit of Korean Patent Application No. 10-2022-0176084 filed on Dec. 15, 2022, in the Korean Intellectual Property Office, the entire disclosure of which is incorporated herein by reference for all purposes.

### BACKGROUND

### 1. Field of the Invention

One or more embodiments relate to a polyimide resin composition, a polyimide-based adhesive composition including the same, a polyimide adhesive film, and a flexible metal clad laminate film.

### 2. Description of the Related Art

In general, polyimide (PI) is diversely used in fields requiring strong organic materials such as high-temperature fuel cells, displays, or military purpose uses, because PI has high heat resistance as a polymer of an imide monomer. The polyimide film is a film made of a polyimide resin, and with the miniaturization and high integration of electronic devices, polyimide in the form of a film has become a material that is in the spotlight.

A flexible printed circuit board (FPCB) is a PCB manufactured to be used when a flexible and thin substrate of a circuit board is required. A flexible metal clad laminate (FMCL) is a basic raw material for FPCB products and includes a conductive metal foil and an insulating layer. Typically, a flexible metal clad laminate film in which a copper foil and polyimide are laminated is being used.

Due to the miniaturization of electronic devices, PCBs are rapidly becoming smaller, lighter, and have narrower pitches, and the development of technology for FPCB materials for high-speed transmission in the fifth-generation (5G) era is required. In other words, as the signal transmission speed of electronic devices rapidly increases, it is necessary to develop an insulator with a dielectric constant and dielectric loss less than those of existing insulators.

The above description has been possessed or acquired by the inventor(s) in the course of conceiving the present disclosure and is not necessarily an art publicly known before the present application is filed.

### SUMMARY

As the signal transmission speed of electronic devices rapidly increases, an insulator with a dielectric constant and dielectric loss less than those of existing insulators may need to be developed. Accordingly, a variety of research is being conducted to enhance dielectric properties of an insulating resin (e.g. polyimide) forming a flexible metal clad laminate. However, if the molecular weight of polyimide, which is the main insulating resin, increases, a solubility may decrease or it may be difficult to satisfy both a solder heat resistance, and low dielectric loss, due to structural limitations. In addition, when single-molecule polyimide is applied as an adhesive, it may be difficult to manufacture an adhesive sheet for electronic devices (e.g., for flexible metal clad laminate films) due to a difficulty in controlling curing by epoxy.

To solve the above-mentioned problems, embodiments may provide a polyimide resin composition that has a solubility, that is excellent in an adhesive strength and solder heat resistance, and that may realize a low dielectric loss.

One or more embodiments provide a polyimide-based adhesive composition (e.g., a polyimide-based adhesive for electronic devices) including the polyimide resin composition.

One or more embodiments provide a polyimide adhesive sheet or film (e.g., an adhesive sheet or film for electronic devices) manufactured using the polyimide-based adhesive composition.

One or more embodiments provide a flexible metal clad laminate film (e.g., a flexible copper clad laminate film) including the polyimide adhesive sheet or film.

However, the technical goal obtainable from the present disclosure is not limited to those described above, and other goals not mentioned above can be clearly understood by one of ordinary skill in the art to which the present disclosure pertains from the following description.

According to an aspect, there is provided a polyimide resin composition which is derived from a polyimide precursor composition that includes an aliphatic acid anhydride, and an amine including an aromatic diamine and a dimer diamine. The aliphatic acid anhydride may include an aliphatic tetracarboxylic acid anhydride.

According to an embodiment, the aliphatic tetracarboxylic acid anhydride may include an anhydride including at least one of bicyclo(2.2.2)oct-7-ene-2,3,5,6-tetracarboxylic acid dianhydride (BOTDA), 5-(2,5-dioxotetrahydrofuryl)-3-methyl-3-cyclohexene-1,2-dicarboxylic acid (DMCDA), cyclohexane-1,2,4,5-tetracarboxylic acid, [1,1′-bi(cyclohexane)]-3,3′, 4, 4′-tetracarboxylic acid, [1,1′-bi(cyclohexane)]-2,3,3′, 4′-tetracarboxylic acid, [1,1′-bi(cyclohexane)]-2,2′, 3,3′-tetracarboxylic acid, 4,4′-methylenebis(cyclohexane-1,2-dicarboxylic acid), 4,4′-(propane-2,2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), or a mixture thereof.

According to an embodiment, the aromatic diamine may include at least one of one compound A1 selected from a compound represented by Chemical Formula a1, and one compound A2 selected from a compound represented by Chemical Formula a2.

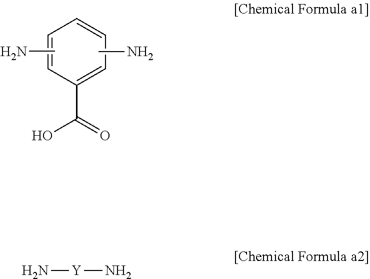

In Chemical Formula a2, Y is at least one of compounds represented by Chemical Formula a3.

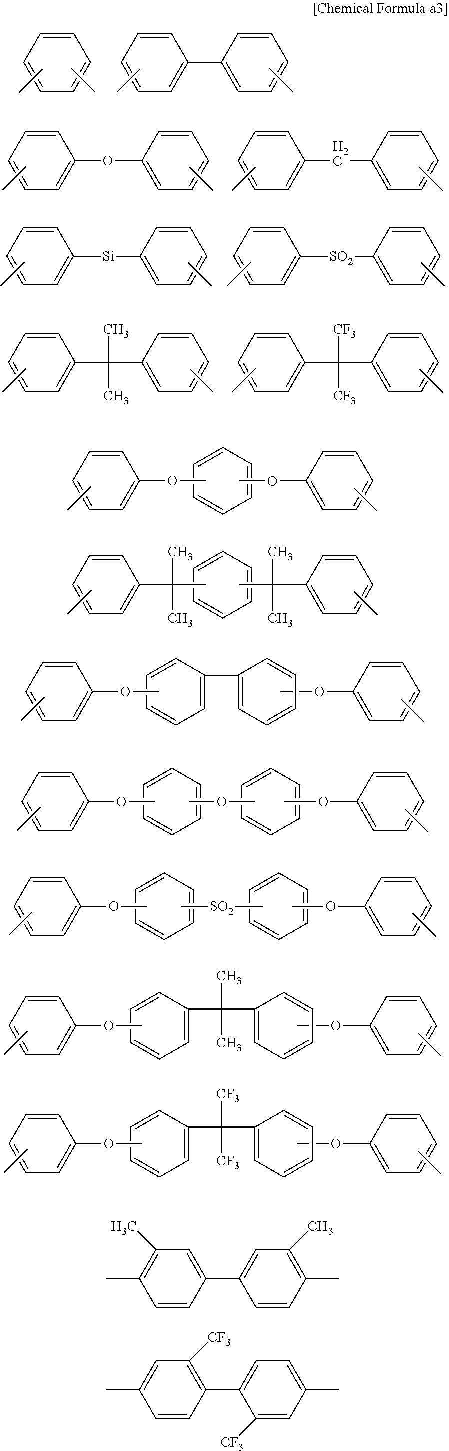

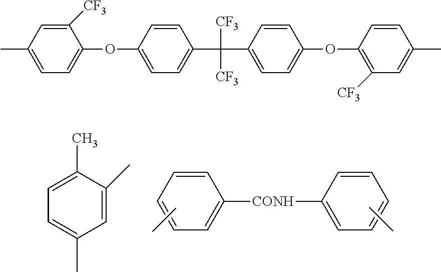

According to an embodiment, the dimer diamine may include at least one of one compound B1 selected from a compound represented by Chemical Formula b1, and one compound B2 selected from a compound represented by Chemical Formula b2.

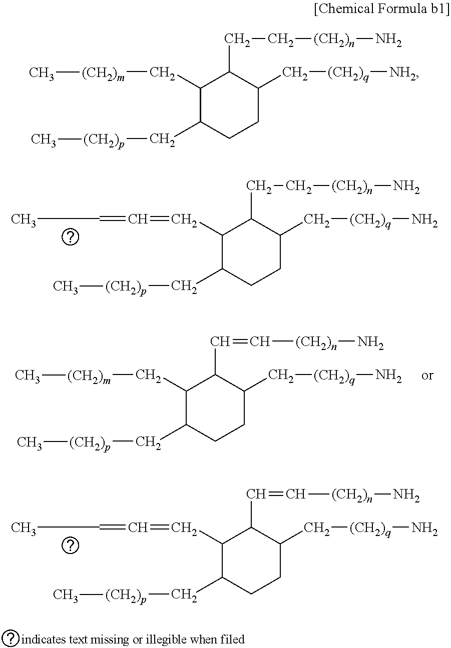

In Chemical Formula b1, “m+n” is an integer of “6” to “17”, “p+q” is an integer of “8” to “19”, and a dashed line indicates a carbon-carbon single bond or a carbon-carbon double bond.

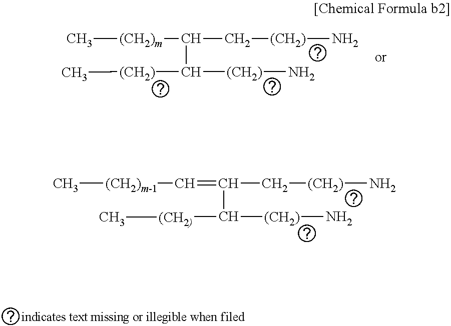

In Chemical Formula b2, “m+n” is an integer of “6” to “17”, and “p+q” is an integer of “8” to “19”

According to an embodiment, a molar ratio of the aromatic diamine:the dimer diamine may be in a range of 1:99 to 99:1.

According to an embodiment, the aliphatic tetracarboxylic acid anhydride may be in an amount of 80% by mole (mol %) or greater in the aliphatic acid anhydride, and the dimer diamine may be in an amount of 10 mol % to 90 mol % in the amine.

According to an embodiment, the aromatic diamine may include at least one of an aromatic diamine having one aromatic ring including at least one of p-phenylenediamine, m-phenylenediamine, 2,4-toluenediamine, m-xylylenediamine, p-xylylenediamine, 1,5-diaminonaphthalene, 2,6-diaminonaphthalene, and 3,5-diaminobenzoic acid; an aromatic diamine having at least two aromatic rings including at least one of m-tolidine (m-TOL), 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenylsulfone, bis[4-(4-aminophenoxy)phenyl]sulfone, bis[4-(3-aminophenoxy)phenyl]sulfone, 2,2-bis[4-(4-aminophenoxy)phenyl] propane, 2,2-bis[4-(3-aminophenoxy))phenyl] propane, 2,2′-dimethylbenzidine, 2,2′-bis(trifluoromethyl) benzidine, 4,4′-bis(4-aminophenoxy)biphenyl, 4,4′-diaminodiphenyl ether, 3,4′-diaminodiphenyl ether, 4,4′-diaminodiphenylmethane, 9,9-bis(4-aminophenyl)fluorene, 9,9-bis(4-amino-3-methylphenyl)fluorene, 9,9-bis(4-amino-3-chlorophenyl)fluorene and 9,9-bis(4-amino-3-fluorophenyl)fluorene; or a mixture thereof.

According to an embodiment, a diamine in the dimer diamine may include at least one of 1,3-bis(aminomethyl)cyclohexane, 1,4-bis(aminomethyl)cyclohexane, 1,4-diaminocyclohexane, 1,4-cyclohexanebis(methylamine), 4,4′-diaminodicyclohexylmethane (MCA), 4,4′-methylenebis(2-methylcyclohexylamine) (MMCA), ethylene diamine (EN), 1,3-diaminopropane (13DAP), tetramethylene diamine, 1,6-hexamethylene diamine (16DAH), 1,12-diaminododecane (112DAD), norbornene diamine, 4,4′-diaminodicyclohexylmethane, or a mixture thereof.

According to an embodiment, a polyimide resin may be obtained by inducing an imidization reaction of a polyimide precursor composition at a temperature of 120° C. to 220° C., and may be soluble.

According to another aspect, there is provided a polyimide-based adhesive composition including the polyimide resin composition according to an embodiment, a curing agent, and a filler.

According to an embodiment, in the polyimide-based adhesive composition, the polyimide resin composition may be in an amount of 10% by weight (wt %) to 90 wt %, the curing agent may be in an amount of 0.01 wt % to 50 wt %, and the filler may be in an amount of 5 wt % to 85 wt %.

According to an embodiment, in the polyimide-based adhesive composition, the polyimide resin composition may be in an amount of 40 wt % to 90 wt %, the curing agent may be in an amount of 0.01 wt % to 5 wt %, and the filler may be in an amount of 10 wt % to 60 wt %.

According to an embodiment, the filler may include a fluorine-based filler, an inorganic filler, or both. The inorganic filler may include at least one of silica, titanium oxide, zirconium oxide, cerium oxide, niobium oxide, zirconium silicate, boron nitride, zinc oxide, aluminum oxide, or a mixture thereof.

According to an embodiment, the fluorine-based filler may include at least one of a tetrafluoroethylene-hexafluoropropylene copolymer (FEP), a tetrafluoroethylene-fluoroalkyl vinyl ether copolymer (PFA), a tetrafluoroethylene-ethylene copolymer (ETFE), a tetrafluoroethylene-hexafluoropropylene-vinylidene fluoride terpolymer (THV), polytetrafluoroethylene (PTFE), polyvinylidene fluoride (PVdF), polychlorotrifluoroethylene (PCTFE), or a mixture thereof.

According to an embodiment, the curing agent may include an epoxy-based curing agent. The epoxy-based curing agent may include at least one of a bisphenol A-type epoxy resin, a bisphenol F-type epoxy resin, a bisphenol AD-type epoxy resin, a phenol novolac-type epoxy resin, a cresol novolac epoxy resin, a phenol novolac epoxy resin, an imide-based epoxy resin, a novolac epoxy resin, a biphenyl-based epoxy resin, or a mixture thereof.

According to another aspect, there is provided a polyimide adhesive film manufactured from the polyimide-based adhesive composition according to an embodiment. The polyimide adhesive film may have a dielectric constant Dₖ of 2.6 or less, and a dielectric loss tangent D_{f} of 0.0010 or greater and 0.01 or less.

According to an embodiment, the polyimide adhesive film may be used for a flexible metal clad laminate film.

According to an embodiment, the polyimide adhesive film may have an adhesive strength of 700 gf/cm² or greater.

According to another aspect, there is provided a flexible metal clad laminate film including a metal foil, and a polyimide adhesive film laminated on one surface or both surfaces of the metal foil. The polyimide adhesive film may be the polyimide adhesive film according to an embodiment.

According to an embodiment, a flexible printed circuit board (FPCB) may include a flexible copper clad laminate film according to an embodiment.

Additional aspects of embodiments will be set forth in part in the description which follows and, in part, will be apparent from the description, or may be learned by practice of the disclosure.

According to embodiments, a polyimide-based adhesive resin composition that may be excellent in an adhesive strength and solder heat resistance, and that may realize a low dielectric loss using a polyimide resin with a solubility, and a polyimide adhesive sheet or film (e.g. an adhesive sheet or film for electronic devices) including the polyimide-based adhesive resin composition may be provided.

### BRIEF DESCRIPTION OF THE DRAWING

These and/or other aspects, features, and advantages of the invention will become apparent and more readily appreciated from the following description of embodiments, taken in conjunction with the accompanying drawing of which:

FIG. 1 schematically illustrates a flexible metal clad laminate film according to an embodiment.

### DETAILED DESCRIPTION

Hereinafter, embodiments will be described in detail with reference to the drawing. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or combinations thereof, but do not preclude the presence or addition of one or more of other features, integers, steps, operations, elements, components, or combinations thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. It is to be understood that if a component is described as being “connected”, “coupled” or “joined” to another component, the former may be directly “connected”, “coupled”, and “joined” to the latter or “connected”, “coupled”, and “joined” to the latter via another component.

Components included in an embodiment and components having a common function will be described using the same names in other embodiments. Unless otherwise mentioned, the descriptions on the embodiments may be applicable to the following embodiments and thus, duplicated descriptions will be omitted for conciseness.

Hereinafter, a polyimide resin composition, and use of the polyimide resin composition will be described in detail with reference to embodiments. However, the present disclosure is not limited to the embodiments.

According to an embodiment, a soluble polyimide resin composition or a polyimide resin which is derived from a polyimide precursor composition that includes an aliphatic acid anhydride, and an amine including an aromatic diamine and a dimer diamine may be provided.

According to an embodiment, the polyimide resin composition may be prepared by a precursor composition including a polyamic acid prepared using an aliphatic acid anhydride, and accordingly, a soluble polyimide resin may be provided and a low dielectric loss may be realized with an excellent adhesive strength and solder heat resistance. For example, the polyimide resin composition may be used as an adhesive film (or sheet) for electronic devices (e.g., for flexible metal clad laminate films).

According to an embodiment, the aliphatic acid anhydride may include an aliphatic tetracarboxylic acid anhydride, and the anhydride may be a dianhydride. For example, the aliphatic tetracarboxylic acid anhydride may be included in an amount of 80% by mole (mol %) or greater; 90 mol % or greater; or about 100 mol % in the aliphatic acid anhydride. Accordingly, a polyimide-based resin with a low dielectric loss by increasing a proportion of the aliphatic acid anhydride may be provided.

For example, the aliphatic tetracarboxylic acid anhydride may include an anhydride (e.g., a dianhydride) including at least one of bicyclo(2.2.2)oct-7-ene-2,3,5,6-tetracarboxylic acid dianhydride (BOTDA), 5-(2,5-dioxotetrahydrofuryl)-3-methyl-3-cyclohexene-1,2-dicarboxylic acid (DMCDA), cyclohexane-1,2,4,5-tetracarboxylic acid, [1,1′-bi(cyclohexane)]-3,3′, 4, 4′-tetracarboxylic acid, [1,1′-bi(cyclohexane)]-2,3,3′, 4′-tetracarboxylic acid, [1,1′-bi(cyclohexane)]-2,2′, 3,3′-tetracarboxylic acid, 4,4′-methylenebis(cyclohexane-1,2-dicarboxylic acid), 4,4′-(propane-2,2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), or a mixture thereof. One aliphatic tetracarboxylic acid anhydride, or at least two aliphatic tetracarboxylic acid anhydrides may be included.

According to an embodiment, the aromatic diamine may be included in an amount of 10 mol % to 90 mol % in the amine. When the amount of the aromatic diamine is within the above range, the solder heat resistance and mechanical strength may be enhanced.

According to an embodiment, the aromatic diamine may include at least one of an aromatic diamine having one aromatic ring including at least one of p-phenylenediamine, m-phenylenediamine, 2,4-toluenediamine, m-xylylenediamine, p-xylylenediamine, 1,5-diaminonaphthalene, 2,6-diaminonaphthalene, and 3,5-diaminobenzoic acid; an aromatic diamine having at least two aromatic rings including at least one of m-tolidine (m-TOL), 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenylsulfone, bis[4-(4-aminophenoxy)phenyl]sulfone, bis[4-(3-aminophenoxy)phenyl]sulfone, 2,2-bis[4-(4-aminophenoxy)phenyl] propane, 2,2-bis[4-(3-aminophenoxy))phenyl] propane, 2,2′-dimethylbenzidine, 2,2′-bis(trifluoromethyl) benzidine, 4,4′-bis(4-aminophenoxy)biphenyl, 4,4′-diaminodiphenyl ether, 3,4′-diaminodiphenyl ether, 4,4′-diaminodiphenylmethane, 9,9-bis(4-aminophenyl)fluorene, 9,9-bis(4-amino-3-methylphenyl)fluorene, 9,9-bis(4-amino-3-chlorophenyl)fluorene and 9,9-bis(4-amino-3-fluorophenyl)fluorene; or a mixture thereof. In some examples, the aromatic diamine may include m-tolidine (m-TOL).

According to an embodiment, the aromatic diamine may include at least one of one compound A1 selected from a compound represented by Chemical Formula a1, and one compound A2 selected from a compound represented by Chemical Formula a2.

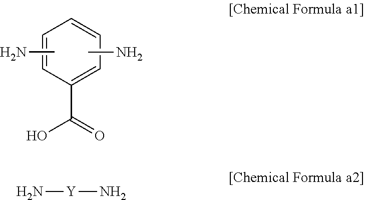

In Chemical Formula a2, Y is at least one of compounds represented by Chemical Formula a3.

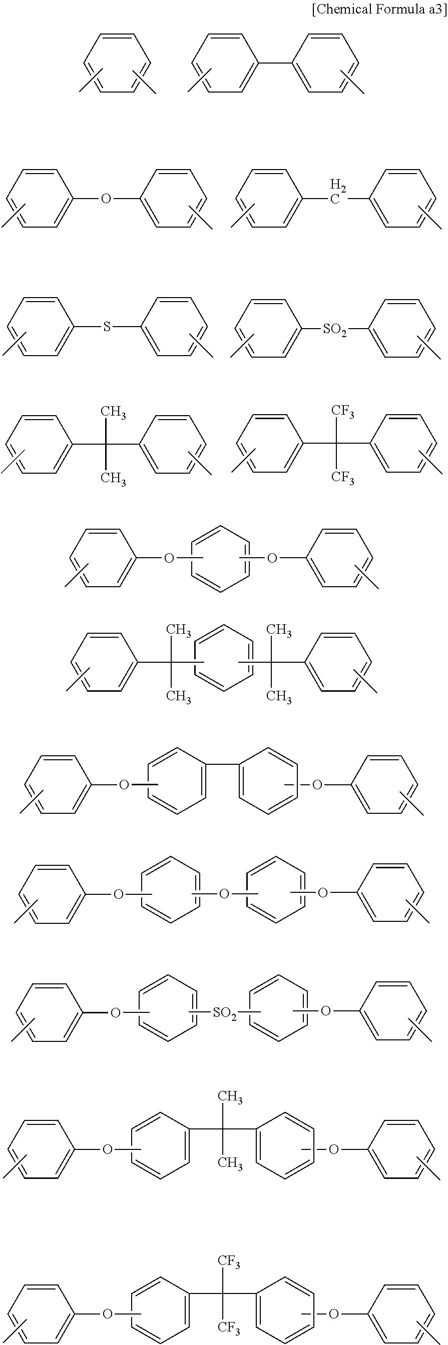

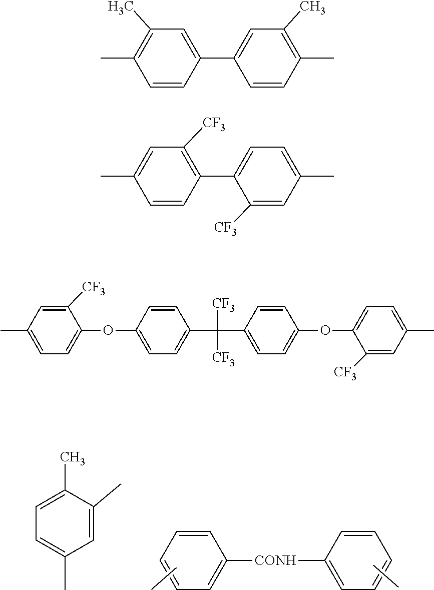

According to an embodiment, the dimer diamine may be in an amount of 10 mol % to 90 mol % in the amine. When the amount of the dimer diamine is within the above range, the solder heat resistance and mechanical strength may be enhanced.

According to an embodiment, the dimer diamine may be an aliphatic diamine. For example, the aliphatic diamine may be saturated aliphatic diamine or unsaturated aliphatic diamine.

According to an embodiment, the dimer diamine may include at least one of one compound B1 selected from a compound represented by Chemical Formula b1, and one compound B2 selected from a compound represented by Chemical Formula b2.

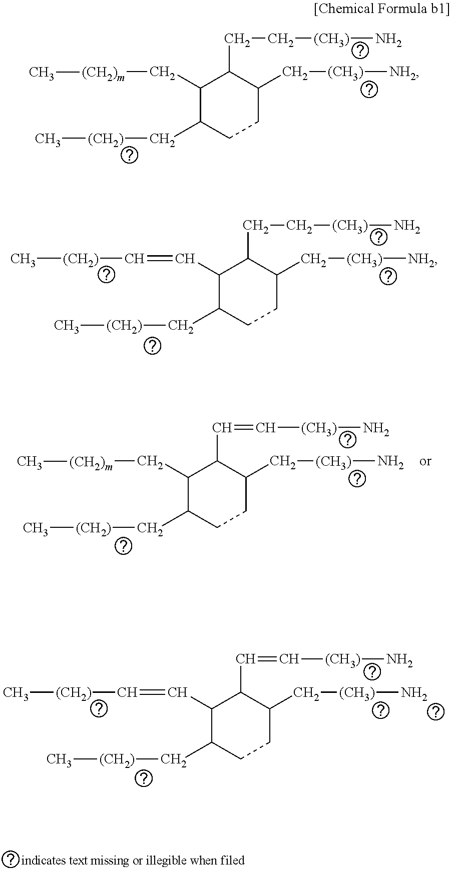

In Chemical Formula b1, “m+n” is an integer of “6” to “17”, “p+q” is an integer of “8” to “19”, and a dashed line indicates a carbon-carbon single bond or a carbon-carbon double bond.

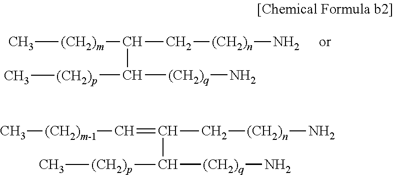

In Chemical Formula b2, “m+n” is an integer of “6” to “17”, and “p+q” is an integer of “8” to “19”.

For example, a diamine in the dimer diamine may include at least one of 1,3-bis(aminomethyl)cyclohexane, 1,4-bis(aminomethyl)cyclohexane, 1,4-diaminocyclohexane, 1,4-cyclohexanebis(methylamine), 4,4′-diaminodicyclohexylmethane (MCA), 4,4′-methylenebis(2-methylcyclohexylamine) (MMCA), ethylene diamine (EN), 1,3-diaminopropane (13DAP), tetramethylene diamine, 1,6-hexamethylene diamine (16DAH), 1,12-diaminododecane (112DAD), norbornene diamine, 4,4′-diaminodicyclohexylmethane, or a mixture thereof.

According to an embodiment, based on 100 moles of an aliphatic acid anhydride (A), an aromatic diamine (B) may be included in an amount of 5 moles to 60 moles, and a dimer diamine (C) may be included in an amount of 39 moles to 94 moles. For example, a ratio of the aromatic diamine (B):the dimer diamine (C) may be in a range of 5:94 to 60:39, based on 100 moles of the aliphatic acid anhydride (A).

According to an embodiment, a method of preparing a polyimide adhesive resin composition may include preparing a polyamic acid composition having a solid content of 30% by weight (wt %) to 60 wt % by mixing an anhydride-based compound and an amine-based compound in a solvent and by performing a polymerization reaction, and performing an imidization reaction of the polyamic acid composition. The amine-based compound may include an aromatic diamine and a dimer diamine.

According to an embodiment, the polymerization reaction may be performed for 5 minutes to 48 hours at a temperature of 20° C. to 100° C.

According to an embodiment, the imidization reaction may be performed for 5 minutes to 48 hours at a temperature of 100° C. to 200° C.

According to an embodiment, the method may further include performing cooling to room temperature after the imidization reaction.

According to an embodiment, the polyimide resin composition may be obtained by inducing an imidization reaction of the polyimide precursor composition. For example, the method may include forming a polyimide precursor composition by mixing an aliphatic acid anhydride and an amine including an aromatic diamine and a dimer diamine, and inducing an imidization reaction of the polyimide precursor composition for 1 hour to 50 hours at a temperature of 140° C. to 200° C.

For example, in the forming of the polyimide precursor composition, the aliphatic acid anhydride may be reacted with the aromatic diamine and the dimer diamine to be polymerized to a polyamic acid polymer.

For example, in the inducing of the imidization reaction, polyimide may be prepared by the imidization reaction of the polyamic acid polymer.

For example, in the inducing of the imidization reaction, a substrate may be coated or cast and may be heated or dried in the above temperature range, to prepare polyimide.

For example, the polyimide precursor composition may further include an organic solvent. The organic solvent may include, for example, N,N-dimethylacetamide (DMAc), N-methyl-2-pyrrolidone (NMP), N,N-dimethylforamide (DMF), dimethyl sulfoxide (DMSO), tetrahydrofuran (TFH), benzene, cresol, hexane, cyclohexane, chloroform, phenol, halogenated phenol, cyclopentanone, cyclohexane, methylcyclohexane, cyclohexanone, butyl acetate, ethyl acetate, isobutyl acetate, propylene glycol methyl acetate, ethyl cellosolve, butyl cellosolve, 2-methyl cellosolve acetate, ethyl cellosolve acetate, butyl cellosolve acetate, tetrahydrofuran, dimethoxy ethane, diethoxy ethane, dibutyl ether, diethylene glycol dimethyl ether, methyl isobutyl ketone, diisobutyl ketone, and the like. Desirably, the organic solvent may include methylcyclohexane, and cyclohexanone.

According to an embodiment, a polyimide-based adhesive composition including the polyimide resin composition according to an embodiment, a curing agent, and a filler may be provided.

According to an embodiment, the polyimide resin composition may be in an amount of 10 wt % to 90 wt %; 40 wt % to 90 wt %; or 40 wt % to 80 wt % in the polyimide-based adhesive composition. When the amount of the polyimide resin composition is within the above range, the adhesive strength and solder heat resistance may be increased, and dielectric properties may be enhanced.

According to an embodiment, the curing agent may be in an amount of 0.01 wt % to 50 wt % in the polyimide-based adhesive composition. When the above range is applied, the adhesive strength and solder heat resistance may be increased, and dielectric properties may be enhanced. According to an embodiment, the curing agent may include an epoxy-based curing agent. The epoxy-based curing agent may include at least one of a bisphenol A-type epoxy resin, a bisphenol F-type epoxy resin, a bisphenol AD-type epoxy resin, a phenol novolac-type epoxy resin, a cresol novolac epoxy resin, a phenol novolac epoxy resin, an imide-based epoxy resin, a novolac epoxy resin, a biphenyl-based epoxy resin, or a mixture thereof. In some examples, the epoxy-based curing agent may include at least one of an imide-based epoxy resin, a novolac epoxy resin, and a biphenyl-based epoxy resin. In some examples, as the epoxy-based curing agent in the polyimide-based adhesive composition, an imide-based epoxy resin, a biphenyl-based epoxy resin, or both may be included in an amount of 0.01 wt % to 50 wt %; and/or a novolac epoxy resin may be included in an amount of 0.01 wt % to 50 wt %.

According to an embodiment, the filler may be in an amount of 5 wt % to 85 wt %; 5 wt % to 60 wt %; 10 wt % to 60 wt %; or 20 wt % to 60 wt % in the polyimide-based adhesive composition.

According to an embodiment, the filler may include a fluorine-based filler, an organic filler, or an inorganic filler. For example, the filler may be in the form of powders, fibers, particles, and the like. In an example, the inorganic filler may include a nitride, an oxide, and the like, and may include, for example, at least one of a glass powder, an aluminum nitride, a boron nitride, a silicon carbide, an aluminum hydroxide, a titanium dioxide, a strontium titanate, barium titanate, barium sulfate, talcum powder, calcium silicate, calcium carbonate, mica, silica, crystalline silica, fused silica, spherical silica, hollow silica, titanium oxide, zirconium oxide, cerium oxide, niobium oxide, zirconium silicate, boron nitride, zinc oxide, aluminum oxide, or a mixture thereof. In an example, the organic filler may include at least one of polytetrafluoroethylene powder, polyphenylene sulfide, polyetherimide, polyphenyl ether, polyethersulfone powder, or a mixture thereof.

According to an embodiment, the fluorine-based filler may include a resin including fluorine, a filler coated with the resin including fluorine, and the like, and may include, for example, a tetrafluoroethylene-hexafluoropropylene copolymer (FEP), a tetrafluoroethylene-fluoroalkyl vinyl ether copolymer (PFA), a tetrafluoroethylene-ethylene copolymer (ETFE), a tetrafluoroethylene-hexafluoropropylene-vinylidene fluoride terpolymer (THV), polytetrafluoroethylene (PTFE), polyvinylidene fluoride (PVdF), polychlorotrifluoroethylene (PCTFE), or a mixture thereof. For example, the fluorine-based filler may be obtained by attaching the resin including fluorine to a substrate, such as an organic fiber, a carbon fiber, a glass fiber, or carbon.

According to an embodiment, the polyimide-based adhesive composition may include a balance of an organic solvent. The organic solvent may include, for example, N,N-dimethylacetamide (DMAc), N-methyl-2-pyrrolidone (NMP), N,N-dimethylforamide (DMF), dimethyl sulfoxide (DMSO), tetrahydrofuran (TFH), benzene, cresol, hexane, cyclohexane, chloroform, phenol, halogenated phenol, cyclopentanone, cyclohexane, methylcyclohexane, cyclohexanone, butyl acetate, ethyl acetate, isobutyl acetate, propylene glycol methyl acetate, ethyl cellosolve, butyl cellosolve, 2-methyl cellosolve acetate, ethyl cellosolve acetate, butyl cellosolve acetate, tetrahydrofuran, dimethoxy ethane, diethoxy ethane, dibutyl ether, diethylene glycol dimethyl ether, methyl isobutyl ketone, diisobutyl ketone, and the like. Desirably, the organic solvent may include methylcyclohexane, and cyclohexanone.

According to an embodiment, a polyimide adhesive film may be provided. The polyimide adhesive film may be manufactured from the polyimide-based adhesive composition according to an embodiment and may have a dielectric constant Dₖ of 2.6 or less and a dielectric loss tangent D_{f} of 0.0010 or greater and 0.01 or less. According to an embodiment, the polyimide adhesive film may be used for a flexible metal clad laminate film.

According to an embodiment, the polyimide adhesive film may have an adhesive strength of 700 gf/cm² or greater, and a solder heat resistance at 288° C./3 minutes or greater. In other words, by applying the polyimide-based resin that includes the aliphatic acid anhydride compound and that has a low dielectric loss, the polyimide adhesive film may be used as an adhesive film for a flexible metal clad laminate film having both a low dielectric loss and solder heat resistance.

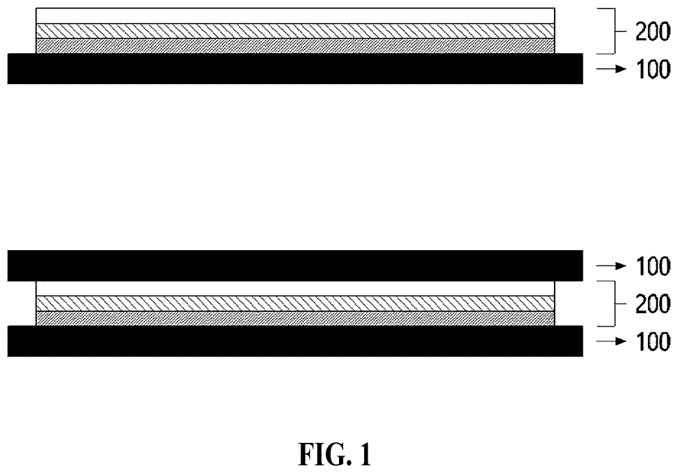

According to an embodiment, referring to FIG. 1, a configuration of a flexible metal clad laminate film 1 according to an embodiment is illustrated. Referring to FIG. 1, the flexible metal clad laminate film 1 may include a polyimide adhesive film layer 200 laminated on one surface or both surfaces of a metal film or a flexible polymer film 100. For example, a flexible metal clad laminate film including a metal foil, and a polyimide adhesive film laminated on one surface or both surfaces of the metal foil may be provided.

According to an embodiment, the polyimide adhesive film layer 200 may be formed by coating a substrate one time or multiple times. The substrate may be the metal film or the flexible polymer film 100, and may be a release film. In an example, the polyimide adhesive film layer 200 may be formed and laminated on one surface or both surfaces of the metal film or the flexible polymer film 100. In another example, the polyimide adhesive film layer 200 may be formed on a release film, and the metal film or the flexible polymer film 100 may be laminated.

According to an embodiment, the polyimide adhesive film layer 200 may be formed by coating one surface or both surfaces of the substrate with the polyimide-based adhesive composition according to an embodiment. For example, the coating may be performed by slot die coating, comma coating, reverse comma coating, cast coating, or dip coating.

According to an embodiment, the coating may be performed multiple times, and drying may be performed together after coating. The drying may be performed at a temperature of 100° C. to 200° C. for 1 minute to 20 minutes, may be retained at the highest temperature for 1 minute to 8 minutes, and may then be cooled.

According to an embodiment, the polyimide adhesive film layer 200 may be cured after the coating. For example, the curing may be performed under a nitrogen atmosphere, may be performed at a temperature of 300° C. to 400° C. for 5 to 60 minutes, may be retained at the highest temperature for 1 minute to 15 minutes, and may then be cooled. In this example, the temperature may be raised to the highest temperature for 5 to 30 minutes.

According to an embodiment, the metal film may include at least one of a rolled-annealed (RA) copper foil, an electrodeposited (ED) copper foil, an aluminum foil, and a nickel foil.

According to an embodiment, the flexible polymer film 100 may include a flexible polymer. The flexible polymer may include, for example, at least one of polyimide (PI), polyethylene terephthalate (PETE), parylene, polyethylene (PE), polyethersulfone (PES), acrylic, naphthalene, polycarbonate (PC), polyester, polyurethane (PU), polystyrene (PS), polyacetylene, or a mixture thereof.

According to an embodiment, the polyimide adhesive film layer 200 may have a thickness of 5 micrometers (μm) to 100 μm; 10 μm to 80 μm; 10 μm to 50 μm; or 10 μm to 20 μm. When the thickness of the polyimide adhesive film layer 200 is within the above thickness range, a sufficient adhesive strength and flexibility may be provided to the flexible metal clad laminate film 1.

Hereinafter, the present disclosure will be described in more detail with reference to examples and comparative examples. However, the following examples are only for illustrating the present disclosure, and the present disclosure is not limited to the following examples.

### Example 1

After cyclohexanone and methylcyclohexane as solvents were added in a nitrogen atmosphere, 100 mol % of DMCDA as an aliphatic acid anhydride was dissolved. After DMCDA was sufficiently dissolved, 15 mol % of amine-based m-TOL and 84 mol % of dimer diamine (DDA, “Priamine 1075”) were added, to prepare a primary polyamic acid composition with a total solid content of 40 wt %. The prepared polyamic acid composition was heated at a temperature of 140° C. to 160° C. for 24 hours and cooled to room temperature, and the reaction was terminated, to obtain a soluble polyimide solution.

### Example 2

A soluble polyimide solution was obtained through the same process as in Example 1, except that 55 mol % of m-TOL and 44 mol % of DDA were added according to Table 1.

### Comparative Example 1

A soluble polyimide solution was obtained through the same process as in Example 1, except that 100 mol % of BPADA, 55 mol % of m-TOL, and 44 mol % of DDA were added.

### Comparative Example 2

A soluble polyimide solution was obtained through the same process as in Example 1, except that 100 mol % of BPDA, 15 mol % of m-TOL, and 84 mol % of DDA were added.

Table 1 shows an amount of an anhydride applied to a synthesis in Examples 1 and 2 and Comparative Examples 1 and 2, an amount of an amine of the synthesized polyimide solution, and physical properties (e.g., a possibility of tack welding, a presence or an absence of tack, and a softening point Ts).

TABLE 1

| | Amount | | | | | | |
|---|---|---|---|---|---|---|---|
| | (mol %) of | | | | | | |
| | anhydride | Amount (mol %) | | | | | |
| | Aliphatic | of amine | | | Possibility | With/ | |
| | acid | Aromatic | Aliphatic | | of tack | Without | Ts |
| Classification | anhydride | diamine | diamine | Solubility | welding | Tack | (° C.) |
| Example 1 | DMCDA | m-TOL | DDA | ◯ | ◯ | Free | 80 |
| | (100) | (15) | (84) | | | | |
| Example 2 | DMCDA | m-TOL | DDA | ◯ | ◯ | Free | 140 |
| | (100) | (55) | (44) | | | | |
| Comparative | BPADA | m-TOL | DDA | ◯ | X | Free | 150 |
| Example 1 | (100) | (55) | (44) | | | | |
| Comparative | BPDA | m-TOL | DDA | X | X | Free | — |
| Example 2 | (100) | (15) | (84) | | | | |

*DDA = Dimer diamine (Priamine 1075)

In Table 1, it can be confirmed that the polyimide solutions of Examples 1 and 2 in which the aliphatic acid anhydrides were applied have a solubility and a softening point of 80° C. or greater. In addition, the polyimide solutions may be used as an adhesive because tack does not occur at room temperature.

### Preparation of Laminate

### Laminate 1

### Preparation of Adhesive Solution

70.35 g of a polyimide (PI) resin prepared in Example 1, 1.26 g of an imide-type epoxy resin (PA-806, epoxy value=119 g/eq, manufactured by Kukdo Chemical Co., Ltd.), 0.22 g of a novolac-based epoxy resin (YDCN-704L, epoxy value=207 g/eq, manufactured by Kukdo Chemical Co., Ltd.), and 40 g of an inorganic filler (fluorine and silica) were sufficiently dissolved in cyclohexanone that is an organic solvent, to prepare an adhesive solution for a flexible copper clad laminate (FCCL).

### Lamination Process

The prepared adhesive solution was applied to one surface of a silicone release-treated PET film (SG31 (product name), manufactured by SKC Co., Ltd., thickness of 36 μm) and used as a support. Subsequently, heading and drying were performed in a hot air oven at 160° C. for 8 minutes, so that the adhesive solution was formed as a sheet, to prepare an adhesive sheet for an FCCL. Polyimide for an FCCL with a thickness of 12.5 μm was placed on both surfaces of the prepared adhesive sheet, and heat-pressing was performed at 175° C. and 40 kgf for 60 minutes, to prepare a laminate 1.

### Laminate 2

A laminate 2 was prepared through the same process as laminate 1, except that a polyimide (PI) resin prepared in Example 2 was used.

### Laminate 3

A laminate 3 was prepared through the same process as laminate 1, except that a polyimide (PI) resin prepared in Comparative Example 1 was used.

### Evaluation of Physical Properties of Laminate

An adhesive strength, a solder heat resistance, dielectric properties, a modulus, and an elongation of the prepared laminate were measured, and the results thereof are shown in Table 2.

### Adhesive Strength

After removing a protective film of an adhesive prepared in each of Examples 1 and 2 and Comparative Examples 1 and 2, a PI film (PI Advanced Materials Co., Ltd.) with a thickness of 1 millimeter (mm) was laminated on both surfaces of the adhesive, and then attached using a hot press under conditions of 175° C., 60 minutes, and 30 kgf. Characteristics of adhesion with the PI film were evaluated by applying a peel tester in accordance with IPC-TM-650 2.4.9D.

### Solder Heat Resistance

After removing the protective film of the polyimide resin adhesive prepared in each of Examples 1 and 2 and Comparative Examples 1 and 2, a PI film (PI Advanced Materials Co., Ltd.) with a thickness of 1 mm was laminated on both surfaces of the adhesive, and then attached using a hot press under conditions of 175° C., 60 minutes, and 40 kgf. An external appearance of the sample was observed by floating the above laminate in a molten lead bath at 288° C. for 3 minutes in accordance with IPC-TM-650 2.4.13. As a result, an evaluation of “NG” was made in a case in which bubbles were generated, and an evaluation of “PASS” was made in a case in which bubbles were not generated.

### Evaluation of Tack Welding

After removing the protective film of the polyimide resin adhesive prepared in each of Examples 1 and 2 and Comparative Examples 1 and 2, the adhesive was laminated on a PI film (PI Advanced Materials Co., Ltd.) with a thickness of 1 mm under conditions of 100° C.×6 mpm, and a protective film of the opposite surface of the adhesive was removed. Here, a case in which the adhesive is fixed and is not peeled off was marked as “O”, a case in which the adhesive is partially peeled off was marked as “A”, and a case in which no peeling occurs was marked as “X”.

### Measurement of Dielectric Constant

A dielectric loss was measured using a resonant cavity method using a network analyzer from Keysight. The specimen had a copper foil/adhesive/copper foil laminate structure, and the copper foil was removed after hot pressing, to obtain an adhesive layer (bonding sheet). After drying was performed at 120° C., moisture in an insulating layer was removed. Each specimen was stored in a 23° C./50% RH thermo-hygrostat for 24 hours, and then the dielectric loss was measured in a hygroscopic environment.

### Tensile Strength

A UTM (INSTRON-3345) was used, and each laminate was cut into 10 mm width and 100 mm length (in a measurement coverage range of 50 mm) and measured at a speed of 50.8 mm/min.

TABLE 2

| | | | | | | | | | solder | | |
|---|---|---|---|---|---|---|---|---|---|---|---|
| | | | | Amount | | | | | heat | | |
| | Adhesive | | Amount | (wt %) of | Possibility | Dielectric properties | | Adhesive | resistance | | |
| | | Amount | (wt %) | inorganic | of tack | (23° C., 50% RH) | | strength | (288° C./ | Modulus | Elongation |
| Classification | Polyimide | (wt %) | of epoxy | filler | welding | Dk | Df | (gf/cm²) | 3 min) | (Gpa) | (%) |
| Laminate 1 | Example 1 | 58 | 2 | 40 | ◯ | 2.43 | 0.00229 | 1,242 | PASS | 0.673 | 125 |
| Laminate 2 | Example 2 | 58 | 2 | 40 | ◯ | 2.48 | 0.00297 | 735 | PASS | 1.551 | 3.8 |
| Laminate 3 | Comparative | 58 | 2 | 40 | X | 2.55 | 0.00362 | 352 | NG | 1.867 | 3.7 |
| | Example 1 | | | | | | | | | | |
| Laminate 4 | Comparative | — | — | — | — | Unmea- | Unmea- | Unmea- | Unmea- | Unmea- | Unmea- |
| | Example 2 | | | | | surable | surable | surable | surable | surable | surable |

As shown in Table 2, it can be confirmed that the laminates 1 and 2 prepared using the polyimide resins of Examples 1 and 2 are excellent in the adhesive strength and solder heat resistance and have a low dielectric loss, in comparison to the laminates 3 and 4 prepared using the polyimide resins of Comparative Examples 1 and 2. In other words, it can be confirmed that the laminates 1 and 2 satisfy the conditions of the adhesive strength of 700 gf/cm² or greater and the solder heat resistance at 288° C./3 min. In addition, in the dielectric loss of the laminates 1 and 2, Dₖ of 2.6 or less and D_{f} of 0.01 or less may be secured.

It can be confirmed that laminates with the applied adhesive compositions of Examples 1 and 2 have an elongation and a modulus value applicable to a copper clad laminate.

While the embodiments are described with reference to drawing, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if described components are combined in a different manner and/or replaced or supplemented by other components or their equivalents. Therefore, other implementations, other embodiments, and equivalents to the claims are also within the scope of the following claims.

What is claimed is:

1. A polyimide resin composition which is derived from a polyimide precursor composition comprising an aliphatic acid anhydride; and an amine including an aromatic diamine and a dimer diamine,
wherein the aliphatic acid anhydride comprises an aliphatic tetracarboxylic acid anhydride.

2. The polyimide resin composition of claim 1, wherein the aliphatic tetracarboxylic acid anhydride is an anhydride comprising at least one selected from a group consisting of bicyclo(2.2.2)oct-7-ene-2,3,5,6-tetracarboxylic acid dianhydride (BOTDA), 5-(2,5-dioxotetrahydrofuryl)-3-methyl-3-cyclohexene-1,2-dicarboxylic acid (DMCDA), cyclohexane-1,2,4,5-tetracarboxylic acid, [1,1′-bi(cyclohexane)]-3,3′, 4, 4′-tetracarboxylic acid, [1,1′-bi(cyclohexane)]-2,3,3′, 4′-tetracarboxylic acid, [1,1′-bi(cyclohexane)]-2,2′, 3,3′-tetracarboxylic acid, 4,4′-methylenebis(cyclohexane-1,2-dicarboxylic acid), 4,4′-(propane-2,2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), or a mixture thereof.

3. The polyimide resin composition of claim 1, wherein the aromatic diamine comprises at least one of:
one compound A1 selected from a compound represented by Chemical Formula a1; and
one compound A2 selected from a compound represented by Chemical Formula a2, 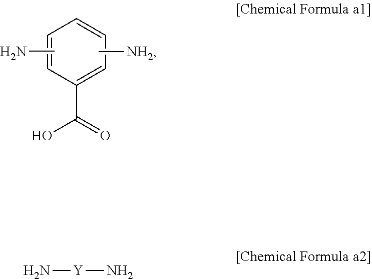
wherein, in Chemical Formula a2, Y is at least one selected from a group consisting of compounds represented by Chemical Formula a3,

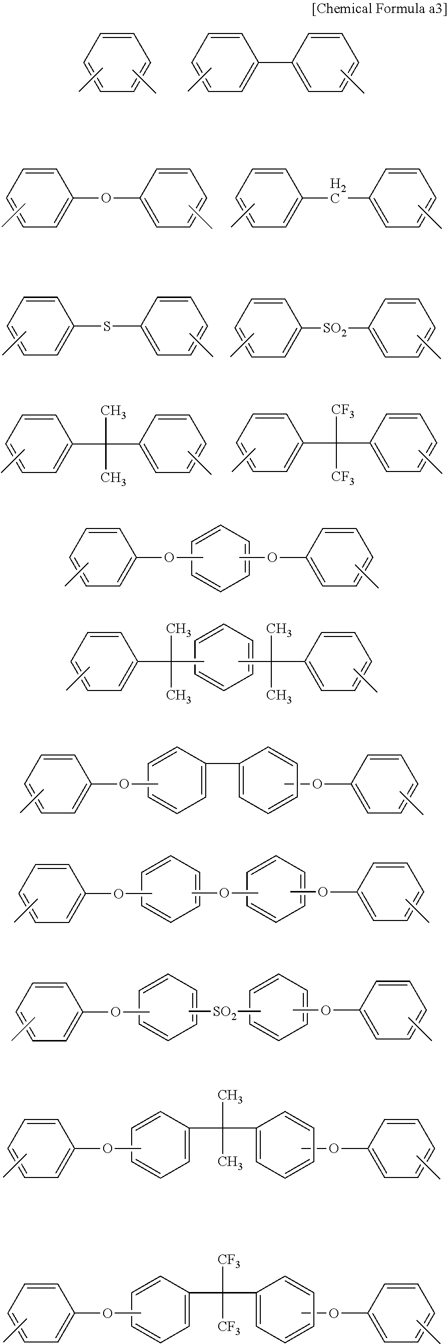

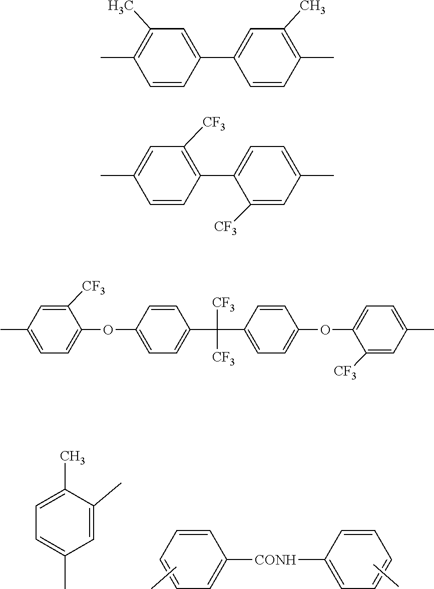

4. The polyimide resin composition of claim 1, wherein the aromatic diamine comprises at least one of:
an aromatic diamine having one aromatic ring comprising at least one selected from a group consisting of p-phenylenediamine, m-phenylenediamine, 2,4-toluenediamine, m-xylylenediamine, p-xylylenediamine, 1,5-diaminonaphthalene, 2,6-diaminonaphthalene, and 3,5-diaminobenzoic acid;
an aromatic diamine having at least two aromatic rings comprising at least one selected from a group consisting of m-tolidine (m-TOL), 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenylsulfone, bis[4-(4-aminophenoxy)phenyl]sulfone, bis[4-(3-aminophenoxy)phenyl]sulfone, 2,2-bis[4-(4-aminophenoxy)phenyl] propane, 2,2-bis[4-(3-aminophenoxy))phenyl] propane, 2,2′-dimethylbenzidine, 2,2′-bis(trifluoromethyl) benzidine, 4,4′-bis(4-aminophenoxy)biphenyl, 4,4′-diaminodiphenyl ether, 3,4′-diaminodiphenyl ether, 4,4′-diaminodiphenylmethane, 9,9-bis(4-aminophenyl)fluorene, 9,9-bis(4-amino-3-methylphenyl)fluorene, 9,9-bis(4-amino-3-chlorophenyl)fluorene and 9,9-bis(4-amino-3-fluorophenyl)fluorene; or
a mixture thereof.

5. The polyimide resin composition of claim 1, wherein the dimer diamine comprises at least one of:
one compound B1 selected from a compound represented by Chemical Formula b1; and
one compound B2 selected from a compound represented by Chemical Formula b2, 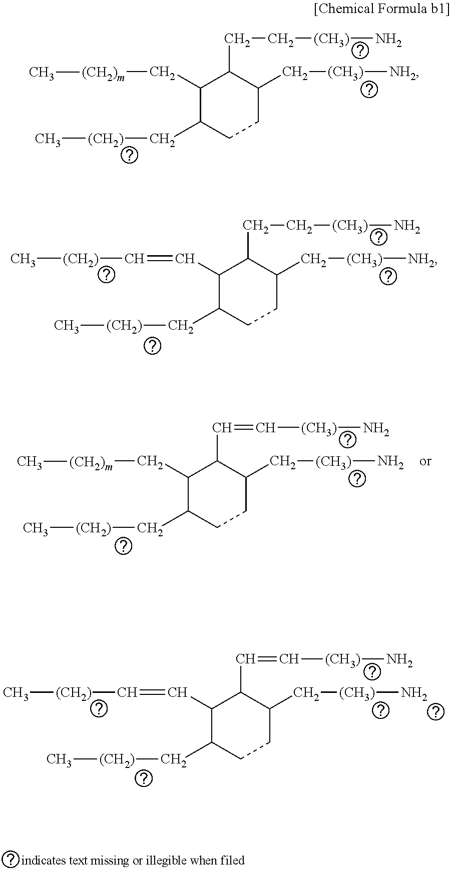
wherein, in Chemical Formula b1, “m+n” is an integer of “6” to “17”, “p+q” is an integer of “8” to “19”, and a dashed line indicates a carbon-carbon single bond or a carbon-carbon double bond, 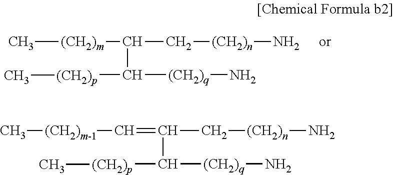
wherein, in Chemical Formula b2, “m+n” is an integer of “6” to “17”, and “p+q” is an integer of “8” to “19”.

6. The polyimide resin composition of claim 1, wherein a diamine in the dimer diamine comprises at least from one selected a group consisting of 1,3-bis(aminomethyl)cyclohexane, 1,4-bis(aminomethyl)cyclohexane, 1,4-diaminocyclohexane, 1,4-cyclohexanebis(methylamine), 4,4′-diaminodicyclohexylmethane (MCA), 4,4′-methylenebis(2-methylcyclohexylamine) (MMCA), ethylene diamine (EN), 1,3-diaminopropane (13DAP), tetramethylene diamine, 1,6-hexamethylene diamine (16DAH), 1,12-diaminododecane (112DAD), norbornene diamine, 4,4′-diaminodicyclohexylmethane, or a mixture thereof.

7. The polyimide resin composition of claim 1, wherein a molar ratio of the aromatic diamine:the dimer diamine is in a range of 1:99 to 99:1.

8. The polyimide resin composition of claim 1, wherein the aliphatic tetracarboxylic acid anhydride is in an amount of 80% by mole (mol %) or greater in the aliphatic acid anhydride.

9. The polyimide resin composition of claim 1, wherein a polyimide resin is obtained by inducing an imidization reaction of a polyimide precursor composition at a temperature of 140° C. to 200° C., and is soluble.

10. A polyimide-based adhesive composition comprising:
the polyimide resin composition of claim 1;
a curing agent; and
a filler.

11. The polyimide-based adhesive composition of claim 10, wherein, in the polyimide-based adhesive composition,
the polyimide resin composition is in an amount of 10% by weight (wt %) to 90 wt %,
the curing agent is in an amount of 0.01 wt % to 50 wt %, and
the filler is in an amount of 5 wt % to 85 wt %.

12. The polyimide-based adhesive composition of claim 10, wherein the filler comprises a fluorine-based filler, an inorganic filler, or both,
wherein the inorganic filler comprises at least one selected from a group consisting of silica, titanium oxide, zirconium oxide, cerium oxide, niobium oxide, zirconium silicate, boron nitride, zinc oxide, aluminum oxide, or a mixture thereof.

13. The polyimide-based adhesive composition of claim 12, wherein the fluorine-based filler comprises at least one selected from a group consisting of a tetrafluoroethylene-hexafluoropropylene copolymer (FEP), a tetrafluoroethylene-fluoroalkyl vinyl ether copolymer (PFA), a tetrafluoroethylene-ethylene copolymer (ETFE), a tetrafluoroethylene-hexafluoropropylene-vinylidene fluoride terpolymer (THV), polytetrafluoroethylene (PTFE), polyvinylidene fluoride (PVdF), polychlorotrifluoroethylene (PCTFE), or a mixture thereof.

14. The polyimide-based adhesive composition of claim 10, wherein
the curing agent comprises an epoxy-based curing agent, and
the epoxy-based curing agent comprises at least one selected from a group consisting of a bisphenol A-type epoxy resin, a bisphenol F-type epoxy resin, a bisphenol AD-type epoxy resin, a phenol novolac-type epoxy resin, a cresol novolac epoxy resin, a phenol novolac epoxy resin, an imide-based epoxy resin, a novolac epoxy resin, a biphenyl-based epoxy resin, or a mixture thereof.

15. A flexible metal clad laminate film, comprising:
a metal foil; and
a polyimide adhesive film laminated on one surface or both surfaces of the metal foil,
wherein the polyimide adhesive film is manufactured from the polyimide-based adhesive composition of claim 10.

16. The flexible metal clad laminate film of claim 15, wherein the metal foil comprises at least one selected from a group consisting of a rolled-annealed (RA) copper foil, an electrodeposited (ED) copper foil, an aluminum foil, and a nickel foil.
